(19) United States
(12) Patent Application Publication
(10) Pub. No.: US 2021/0076787 A1
(43) Pub. Date: Mar. 18, 2021

(54) Found. Loss Prevention Technology

(71) Applicants: Gretchen Bretonya Gloria Farrer, Redding, CA (US); Matthew Edward Farrer, Redding, CA (US)

(72) Inventors: Gretchen Bretonya Gloria Farrer, Redding, CA (US); Matthew Edward Farrer, Redding, CA (US)

(73) Assignee: Matthew Farrer, Redding, CA (US)

(21) Appl. No.: 16/572,489

(22) Filed: Sep. 16, 2019

(51) Int. Cl. A44C 5/00; H04W 4/80; G08B 3/10; G08B 6/00; H04W 4/029

(52) U.S. Cl. CPC A44C 5/0007; H04W 4/80; H04W 4/029; G08B 6/00; G08B 3/1016

(57) ABSTRACT

A system with a wristband and another device to complete the system as mentioned in the claims. The wristband contains the technology in a small compartment part of the bracelet. The other device (that completes the system) has the radio-frequency technology embedded inside and also there will be a sticker made with our technology inside of it to stick on devices mentioned in our claims as Part 2 of the system.

### FIELD

The present application relates to a loss-prevention device with radio frequency technology integrated with the proximity technology. It does not need to charge or have bluetooth connection with anything.

### BACKGROUND

Electronic devices, wallets, purses, all luggages, backpacks, keys/keyrings/keychains, animals, glasses, sunglasses, shoes, bikes, scooters, cars, clothes & kids are lost or stolen at high rates around the world. There are devices existing to prevent loss/theft of items already but require a bluetooth connection to the users smartphone. The problem is that if the phone is off, has dead battery or is broken, the loss prevention device is useless. With our invention, the users wristband (a receiver) will alert them when an item is lost/stolen while they are still within a small radius of the item that has our invention on it.

### SUMMARY

By providing a loss-prevention device with radio-frequency technology instead of bluetooth technology, our invention alerts the user when they are a certain distance away from their designated device/item so as to prevent loss/theft without worrying about their phone being off, having dead battery or being broken. With our invention, the users wristbands will alert them when an item is lost/stolen while they are still within a small radius of the item (that has our invention/technology attached to it). The disclosed exemplary embodiments provides a wristband(a receiver) and a transmitter device, which will be any case, tag and/or sticker that will be attached and/or fitted to the items listed in our claims. For this application we have provided phone case and home hub examples.

### BRIEF DESCRIPTION OF THE DRAWINGS

In the following detailed portion of the present description, the teachings of the present application will be explained in more detail with reference to the example embodiments shown in the drawings, in which:

FIG. 1 is an isometric view of the bracelet,

FIG. 2 is a side view of the bracelet,

FIG. 3 is an aerial view of the phone case,

FIG. 4 is a side view of the phone case,

FIG. 5 is a front view of the home hub,

FIG. 6 is a side view of the home hub

### DETAILED DESCRIPTION

In the following detailed description, the device according to the teachings for this application in the form of a radio-frequency bracelet with proximity, audio and vibration technology will be described by the embodiments.

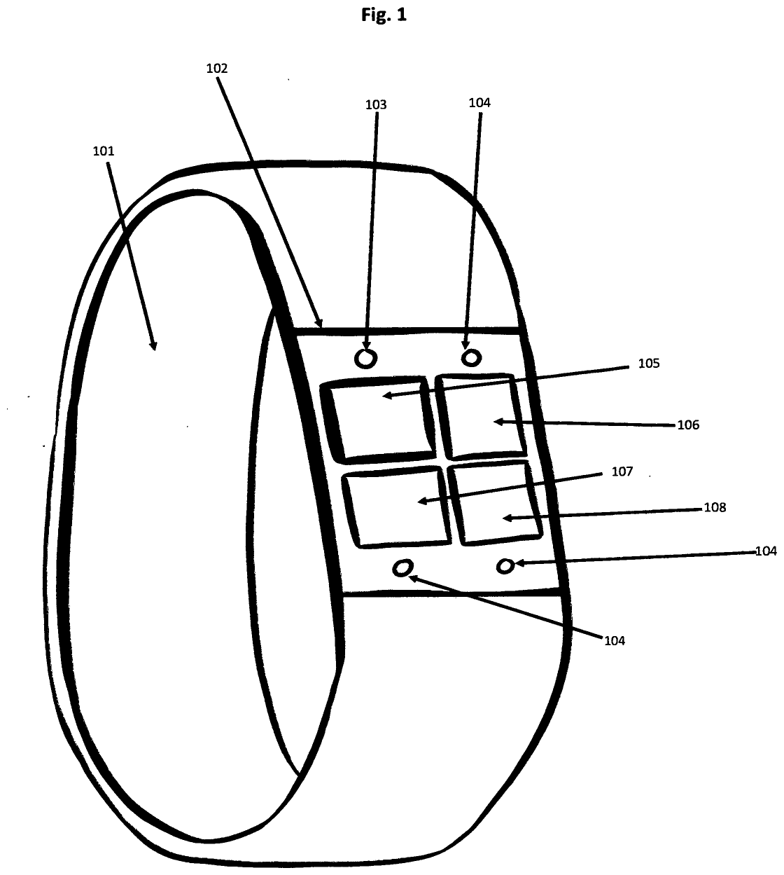

The bracelet is illustrated in FIG. 1 as an isometric view comprising of the following: 101 the shape of the bracelet that has the 102 compartment filled with the majority of the technology, 103 the power button, 104 multi-function buttons 105 the battery, 106 the proximity device integrated with radio-frequency technology, 107 the vibration device and 108 the sound device.

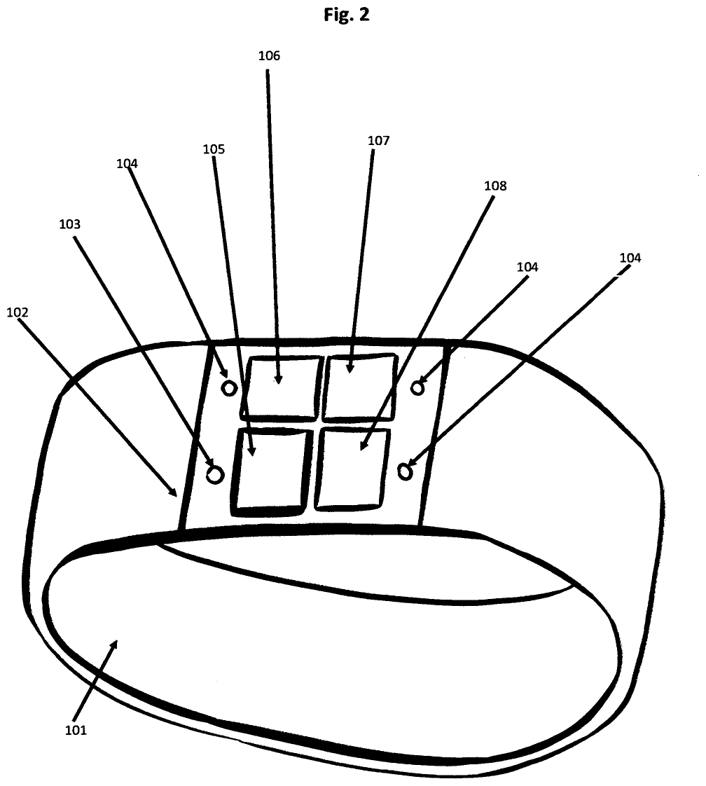

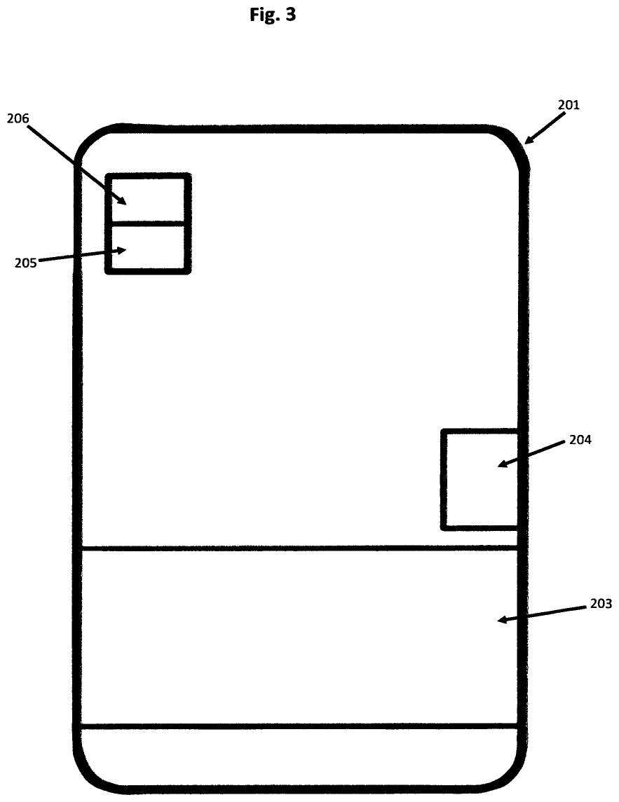

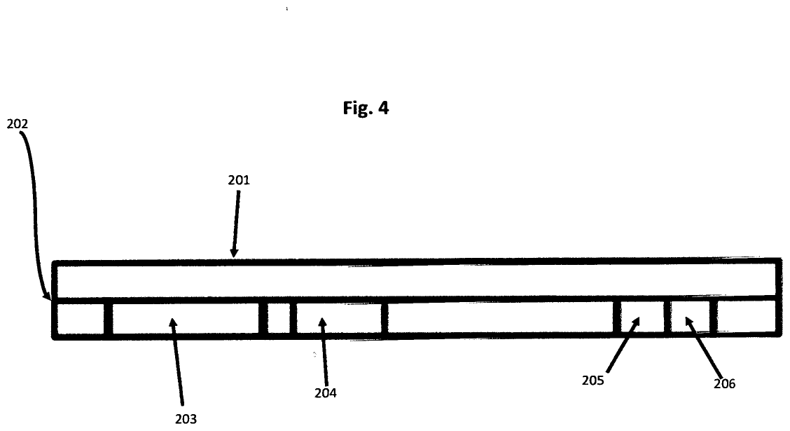

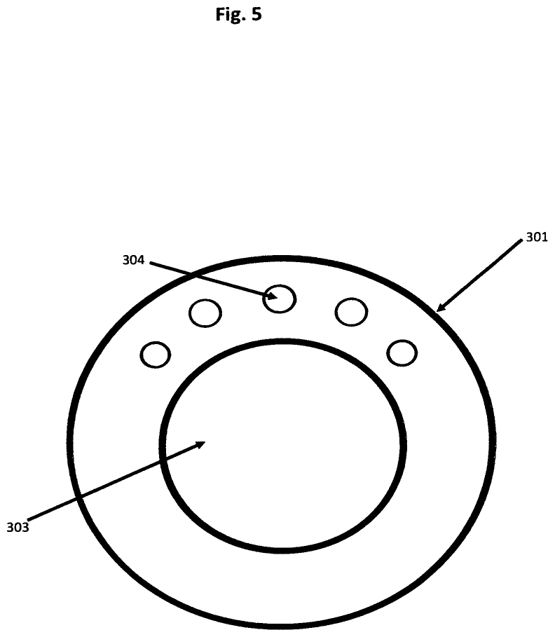

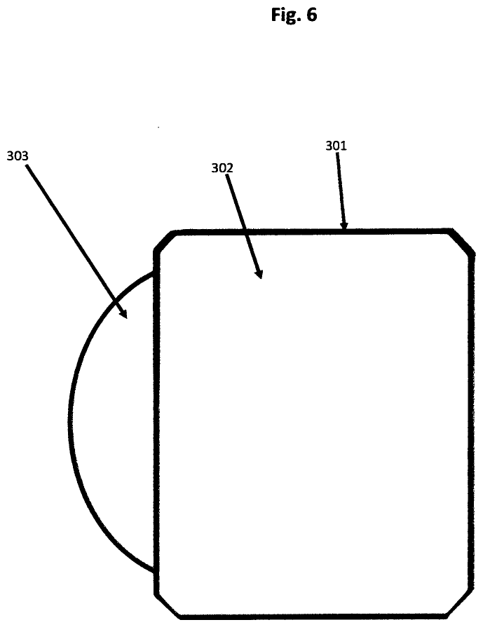

FIG. 2 illustrates the side view of the bracelet. 101 is the shape of the bracelet, 102 is the compartment filled with the majority of the technology. 104 the power button, 105 multi-function buttons, 106 the proximity device integrated with radio-frequency technology, 107 the vibration device and 108 the sound device.
FIG. 3 illustrates the aerial view of the phone case comprising of the following: 201 is the shape of the phone case. 202 is the compartment filled with the majority of the technology. 203 is the battery. 204 is the proximity device. 205 is the vibration device. 206 is the sound device
FIG. 4 illustrates the side view of the phone case. 201 is the shape of the phone case. 202 is the compartment filled with the majority of the technology. 203 is the battery. 204 is the proximity device. 205 is the vibration device. 206 is the sound device
FIG. 5 illustrates the front view of the home hub comprising of the following: 301 is the shape of the hub. 302 is the compartment filled with the majority of the technology. 303 is the power button/multi-function button. 304 is the light display
FIG. 6 illustrates the side view of the home hub. 301 is the shape of the hub. 302 is the compartment filled with the majority of the technology. 303 is the power button/multi-function button

1. A new personal loss-prevention system using radio-frequency for automatically warning a user before an item is lost and/or stolen, comprising of:
at least [1] one receiver, bracelet with predetermined operating distance(s) (including a radio-frequency receiver), being what the user wears;
at least [1] one transmitter device (including a radio-frequency transmitter) with predetermined operating distance(s);
a removable battery and a chargeable battery to operationally power the receiver and a removable battery and a chargeable battery to operationally power at least [1] one transmitter;
a proximity device for operationally connecting the receiver and at least [1] one transmitter with radio-frequency technology;
a vibration device for operationally alerting the receiver and the at least [1] one-transmitter. both with customizable alert settings to have either vibration, sound or both;
a sound device for operationally alerting the receiver and the at least [1] one transmitter, both with customizable alert settings to have either vibration, sound or both:
wherein the receiver and the at least [1] one transmitter device are separated by a separation distance exceeding the predetermined operating distance(s), the at least [1] one transmitter device
transmits the first predetermined signal for the predetermined duration and the receiver bracelet receives the signal for the predetermined duration, both are able to be a water proof water-resistant and/or shockproof housing for the devices

2. According to claim 1, the personal loss-prevention system comprising of a receiver [&] and at least [1] one transmitter is a system that is independently programmable with optional settings,
wherein vibration technology is a programmable option using different unique vibration patterns to signify the type of alerts of battery level, proximity alert, or other alert), wherein sound technology is a programmable option using unique alarm sounds for each predetermined distance, so user can distinguish how far away they are from their child/belonging/pet without looking at their main wristband

3. According to claim 1, the transmitter of the personal loss-prevention system is any item that is integrated with the system which includes a radio-frequency transmitter, battery, proximity, sound and vibration technologies,
wherein the system includes all electronic devices, wallets, purses, all luggages, backpacks, keys/keyrings/keychains, animals, glasses, sunglasses, shoes, bikes, scooters, cars, clothes & kids, adults, seniors, all instruments, necklaces, watches, bracelets

4. According to claim 1, when the transmitter device is separated from the receiver device exceeding the predetermined distance, the proximity technology inside the transmitter device that trigger the transmitter to transmit the predetermined signal for the predetermined duration to the receiver, wherein the transmitter and receiver devices sound and/or vibration technology that triggered by the initial predetermined signal for the predetermined duration

5. According to claim 1, child transmitter device is not limited to just a bracelet and child transmitter device will be used in items that will not easily be lost from the child's body such as shoe inserts, necklace, phone case, sticker, or other similar item.

6. According to claim 1, the child bracelet/unit also has “cut-proof” material option to ensure safety.

7. According to claim 1, all devices contain a battery level status alert that emits a special/unique sound to notify users of battery level that emits a special/unique sound to notify users of battery level being low, giving more than 36 hours notice for low battery.

8. According to claim 1, our system starts with a receiver bracelet and another device (transmitter) to complete the system, wherein there can be multiple transmitter devices linked to the original receiver bracelet, all operating at the same time with different vibrational patterns and sound patterns for proximity alerts from the multiple transmitters to the one or multiple receiver bracelets

9. According to claim 1, the system has the ability to have [2] two receiver bracelets connected to [1] one transmitter child bracelet, pet Collar or other item they don't want lost or stolen.

10. According to claim 1, the receiver bracelet contains the system technology in a small compartment that is removable from the bracelet, the transmitter device (that completes the system) has the radio-frequency technology embedded inside of it

11. According to claim 1, there is a transmitter sticker option to pair with the receiver, it is made with radio-frequency technology inside of it to stick on all devices mentioned in claim 3.

12. According to claim 1, the receiver device has a button that rings the transmitter device that activates a sound in the transmitter device so the receiver user can hear and find the transmitter device.

13. According to claims 1-12, it is therefore an object of the present invention to provide a new and improved radio-frequency loss-prevention system that has all of the advantages of similar previous inventions and none of the disadvantages.

14. According to claims 1-13, in light of all similar devices previously approved, the present invention substantially diverges in design elements from the prior inventions in similar categories and consequently it is clear that there is a need in the art for improvement to existing loss-prevention systems, in this regard this invention substantially fulfills these needs.
